(19) United States
(12) Patent Application Publication
(10) Pub. No.: US 2014/0157411 A1
(43) Pub. Date: Jun. 5, 2014

(54) SAFETY PROTECTION METHOD AND SAFETY PROTECTION DEVICE

(71) Applicant: INSTITUTE FOR INFORMATION INDUSTRY, Taipei (TW)

(72) Inventors: Wei-Chao HSU, Taipei City (TW); Fu-Hau HSU, Taichung City (TW); Chieh-Wen CHEN, Lienchiang County (TW); Ju-Hsuan HE, Yilan County (TW)

(73) Assignee: INSTITUTE FOR INFORMATION INDUSTRY, TAIPEI (TW)

(21) Appl. No.: 13/716,217

(22) Filed: Dec. 17, 2012

(30) Foreign Application Priority Data
Dec. 3, 2012 (TW) 101145322

(51) Int. Cl. G06F 21/56

(52) U.S. Cl. CPC G06F 21/56
USPC 726/23

(57) ABSTRACT

A safety protection method which is performed with a controller includes steps of providing an index table, calling one of the APIs (API), filtering the called API based on a predetermined condition, and blocking the API if the API confirms the predetermined condition. Furthermore, a safety protection device is also disclosed herein.

### RELATED APPLICATIONS

This application claims priority to Taiwan Application Serial Number 101145322, filed Dec. 3, 2012, which is herein incorporated by reference.

### BACKGROUND

1. Field of Invention

The embodiment of the present invention relates generally to a protection device and protection method and, more particularly, to a safety protection device and safety protection method.

2. Description of Related Art

With the development of technology, the threat of malicious software is increasing with each passing day. Security software used to detect malicious software becomes an important information security, and the detection technology becomes an essential capability of antivirus software progressively.

There re two traditional mechanisms to detect malicious software. For instance, security software is used to detect that whether registers are amended, but this mechanism cannot detect malicious software other than amending the registers. In other hand, security software is used to detect that whether processes are amended or terminated, but this mechanism will affect the operation of other processes in the same system.

Many efforts have been devoted trying to find a solution of the aforementioned problems. Nonetheless, there still a need to improve the existing apparatus and techniques in the art.

### SUMMARY

A safety protection device and a safety protection method are provided, which addresses the problem generated by adopting traditional mechanisms to detect malicious software.

One aspect of the embodiment of the present invention is to provide a safety protection method. The safety protection method is implemented by a controller and comprises the steps of:

providing an index table, wherein the index table records a plurality of positions where a plurality of Application Programming Interfaces (API) is stored in a storing device;

calling one of the APIs;

filtering the called API according to a predetermined condition; and

blocking the called API if the called API conforms the predetermined condition.

In one embodiment of the present invention, the predetermined condition comprises a condition of the called API being corresponding to a protected process.

In another embodiment of the present invention, the predetermined condition comprises a condition of the called API being used to amend or terminate a protected process.

In yet another embodiment of the present invention, the predetermined condition comprises a condition of the called API being corresponding to a protected Dynamic Link Library (DLL).

In still another embodiment of the present invention, the predetermined condition comprises a condition of the called API being used to uninstall a protected DLL.

In yet another embodiment of the present invention, the predetermined condition comprises a condition of the called API being used to amend an API of a registry.

In another aspect of the embodiment of the present invention, a safety protection device is provided. The safety protection device stores an index table therein, and the index table records a plurality of positions where a plurality of APIs is stored. The safety protection device comprises an interceptor, a filter, and a blocker. When one of the APIs is called, the interceptor is configured to hook the called API. The filter is configured to filter the called API according to a predetermined condition. The blacker being configured to block the called API if the called API conforms the predetermined condition.

In one embodiment of the present invention, the predetermined condition comprises a condition of the called API being corresponding to a protected process.

In another embodiment of the present invention, the predetermined condition comprises a condition of the called API being used to amend or terminate a protected process.

In yet another embodiment of the present invention, the predetermined condition comprises a condition of the called API being corresponding to a protected DLL.

In still another embodiment of the present invention, the predetermined condition comprises a condition of the called API being used to uninstall a protected DLL.

In yet another embodiment of the present invention, the predetermined condition comprises a condition of the called API being used to amend an API of a registry.

As a result, the embodiments of the present invention provide a safety protection device and a safety protection method, which address the problem of using traditional security software to detect that whether registers are amended, which cannot detect malicious software other than amending the registers. Furthermore, the above-mentioned embodiments can address the problem of using traditional security software to detect that whether processes are amended or terminated, which will affect the operation of other processes in the same system.

### BRIEF DESCRIPTION OF THE DRAWINGS

The invention can be more fully understood by reading the following detailed description of the embodiments, with reference made to the accompanying drawings as follows:

FIG. 1 schematically shows a block diagram of a safety protection device according to embodiments of the present invention.

FIG. 2 schematically shows a flow diagram of a safety protection method according to embodiments of the present invention.

### DETAILED DESCRIPTION

The present invention is more particularly described in the following examples that are intended as illustrative only since numerous modifications and variations therein will be apparent to those skilled in the rt. Various embodiments of the invention are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “Including,” “having,” “containing,” “involving,” and the like are to be understood to be open-ended, i.e., to mean including but not limited to.

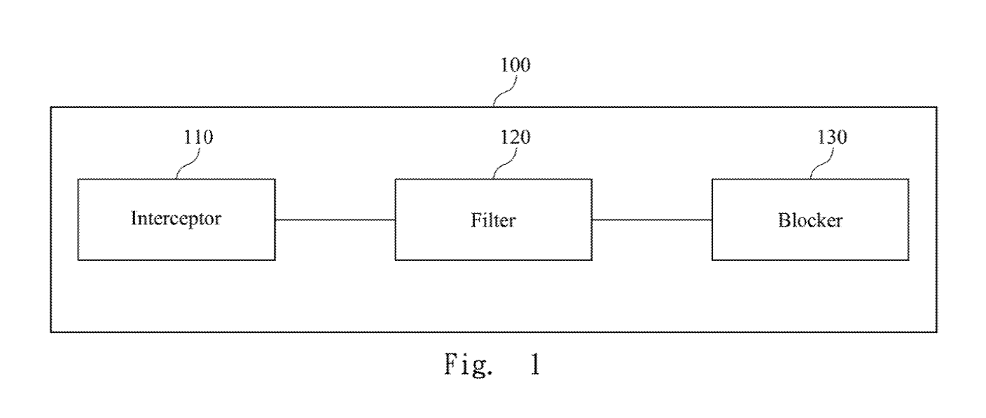

FIG. 1 schematically shows a block diagram of a safety protection device according to embodiments of the present invention. The safety protection device 100 stores an index table. The index table records a plurality of positions where a plurality of Application Programming Interfaces (API) is stored. The safety protection device 100 comprises an interceptor 110, a filter 120, and a blocker 130. When implementing the embodiment of the present invention, the interceptor 110, the filter 120, and the blocker 130 can be an entity element or a virtual machine which is simulated by software depending on actual requirements. In addition, the index table can be but not limited to IAT or KiServiceTable, and this embodiment is only one of implementations to realize the present invention.

With respect to the operation, when one of the APIs is called, the interceptor 110 hooks the called API. The filter 120 is configured to filter the called API according to a predetermined condition. The blocker 130 is configured to block the called API if the called API conforms the predetermined condition.

It is noted that, the step of hooking one of the APIs can also be adopted by malicious software, and the malicious software will use this mechanism to countermeasure the safety protection device 100 of the embodiment of the present invention. Hence, when the system in which the safety protection device 100 of the embodiment of the present invention installs is in initial condition (for example, the electrical device is new or the operation system of the electrical device is reinstalled), the safety protection device 100 will be used to scan the system in advance. As such, the above-mentioned operation can make sure that the system which the safety protection device 100 protects is safe.

In one embodiment of the present invention, the predetermined condition is the called API being corresponding to a protected process. Moreover, the predetermined condition can also be determined whether the called API is the protected process. When the called API is actually corresponding to the protected process, it represents that there is a malicious longing for controlling the protected process, for example, the malicious longs for amending or terminating the protected process. The operation of terminating comprises operations of QUIT, CLOSE, and so on. Meanwhile, the predetermined condition is satisfied, and the blocker 130 blocks the called API.

In another embodiment of the present invention, the predetermined condition is the called API being corresponding to a protected Dynamic Link Library (DLL). Moreover, the predetermined condition can also be determined whether the called API is the protected DLL. When the called API is actually corresponding to the protected DLL, it represents that there is a malicious longing for controlling the protected DLL, for example, the malicious longs for uninstalling the protected DLL. Meanwhile, the predetermined condition is satisfied, and the blocker 130 blocks the called API.

In still another embodiment of the present invention, the predetermined condition is the called API being used to amend an API of a registry. Moreover, the predetermined condition can also be determined whether the called API is used to amend the API of the registry. When the called API is actually used to amend the API of the registry, it represents that there is a malicious longing for amending the registry. Meanwhile, the predetermined condition is satisfied, and the blocker 130 blocks the called API.

Therefore, the embodiments of the present invention provide the safety protection device 100, which address the problem of using traditional security software to detect that whether registers are amended, which cannot detect malicious software other than amending the registers. Furthermore, the above-mentioned embodiments can address the problem of using traditional security software to detect that whether processes are amended or terminated, which will affect the operation of other processes in the same system.

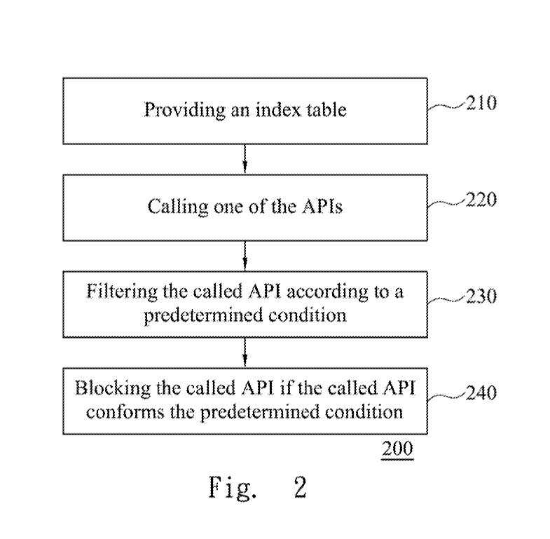

FIG. 2 schematically shows a flow diagram of a safety protection method according to embodiments of the present invention. As shown in Figure, the safety protection method 200 is implemented by a controller, and the safety protection method 200 comprises the steps of:

Step 210: providing an index table, wherein the index table records a plurality of positions where a plurality of APIs is stored in a storing device;

Step 220: calling one of the APIs;

Step 230: filtering the called API according to a predetermined condition; and

Step 240: blocking the called API if the called API conforms the predetermined condition.

In order to make the above-mentioned steps easier to be understood, reference is now made to both FIGS. 1 and 2. In step 210, the safety protection device 100 can be implemented to provide the index table. Subsequently, the step of calling one of the APIs as shown in step 220 can implemented by the safety protection device 100.

Furthermore, in step 230, the filter 120 can implemented to filtering the called API according to the predetermined condition. The step of blocking the called API if the called API conforms the predetermined condition as shown in step 240, can implemented by the blocker 130.

In one embodiment of the present invention, referring to both steps 230 and 240, the predetermined condition is the called API being corresponding to a protected process. Moreover, the predetermined condition can also be determined whether the called API is the protected process. When the called API is actually corresponding to the protected process, it represents that there is a malicious longing for controlling the protected process, for example, the malicious longs for amending or terminating the protected process. The operation of terminating comprises operations of QUIT, CLOSE, and so on. Meanwhile, the predetermined condition is satisfied, and the step 240 is performed to block the called API.

In another embodiment of the present invention, referring to both steps 230 and 240, the predetermined condition is the called API being corresponding to a protected Dynamic Link Library (DLL). Moreover, the predetermined condition can also be determined whether the called API is the protected DLL. When the called API is actually corresponding to the protected DLL, it represents that there is a malicious longing for controlling the protected DLL, for example, the malicious longs for uninstall the protected DLL. Meanwhile, the predetermined condition is satisfied, and the step 240 is performed to block the called API.

In still another embodiment of the present invention, the predetermined condition is the called API being used to amend an API of a registry. Moreover, the predetermined condition can also be determined whether the called API is used to amend the API of the registry. When the called API is actually used to amend the API of the registry, it represents that there is a malicious longing for amending the registry. Meanwhile, the predetermined condition is satisfied, and the step 240 is performed to block the called API.

Those having skill in the art will appreciate that the safety protection method can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the safety protection method named after the function thereof is merely used to describe the technology in the embodiment of the present invention in detail but not limited to. Therefore, combining the steps of said method into one step, dividing the steps into several steps, or rearranging the order of the steps is within the scope of the embodiment in the present invention.

In view of the foregoing embodiments of the present invention, many advantages of the present invention are now apparent. The embodiment of the present invention provides a safety protection device and a safety protection method, which address the problem of using traditional security software to detect that whether registers are amended, which cannot detect malicious software other than amending the registers. Furthermore, the above-mentioned embodiments can address the problem of using traditional security software to detect that whether processes are amended or terminated, which will affect the operation of other processes in the same system.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A safety protection method, wherein the safety protection method is implemented by a controller and comprises:
providing an index table, wherein the index table records a plurality of positions where a plurality of Application Programming Interfaces (API) is stored in a storing device;
calling one of the APIs;
filtering the called API according to a predetermined condition; and
blocking the called API if the called API conforms the predetermined condition.

2. The safety protection method according to claim 1, wherein the predetermined condition comprises a condition of the called API being corresponding to a protected process.

3. The safety protection method according to claim 1, wherein the predetermined condition comprises a condition of the called API being used to amend or terminate a protected process.

4. The safety protection method according to claim 1, wherein the predetermined condition comprises a condition of the called API being corresponding to a protected Dynamic Link Library (DLL).

5. The safety protection method according to claim 1, wherein the predetermined condition comprise condition of the called API being used to uninstall a protected DLL.

6. The safety protection method according to claim 1, wherein the predetermined condition comprises a condition of the called API being used to amend an API of a registry.

7. A safety protection device, wherein the safety protection device stores an index table therein, and the index table records a plurality of positions where a plurality of APIs is stored, and wherein the safety protection device comprises:
an interceptor, wherein when one of the APIs is called, the interceptor is configured to hook the called API;
a filter being configured to filter the called API according to a predetermined condition; and
a blocker being configured to block the called API if the called API conforms the predetermined condition.

8. The safety protection device according to claim 7, wherein the predetermined condition comprises a condition of the called API being corresponding to a protected process.

9. The safety protection device according to claim 7, wherein the predetermined condition comprises condition of the called API being used to amend or terminate a protected process.

10. The safety protection device according to claim 7, wherein the predetermined condition comprises a condition of the called API being corresponding to a protected DLL.

11. The safety protection device according to claim 7, wherein the predetermined condition comprises a condition of the called API being used to uninstall a protected DLL.

12. The safety protection device according to claim 7, wherein the predetermined condition comprises a condition of the called API being used to amend an API of a registry.
